(19) United States
(12) Patent Application Publication
(10) Pub. No.: US 2018/0250866 A1
(43) Pub. Date: Sep. 6, 2018

(54) KNEADING APPARATUS AND METHOD OF PRODUCING KNEADED MATERIAL

(71) Applicant: Sumitomo Chemical Company, Limited, Tokyo (JP)

(72) Inventors: Hirohiko HASEGAWA, Niihama-shi (JP); Shinichi YAMATE, Niihama-shi (JP); Takuya AKIYAMA, Niihama-shi (JP)

(21) Appl. No.: 15/907,994

(22) Filed: Feb. 28, 2018

(30) Foreign Application Priority Data
Mar. 3, 2017 (JP) 2017-041090

(51) Int. Cl. B29C 47/36; B29C 47/92; B29B 7/48; B29B 7/62

(52) U.S. Cl. CPC B29C 47/367; B29C 47/366; B29C 47/92; C08L 23/06; B29B 7/487; B29B 7/625; B29C 2947/9239; B29B 7/482

(57) ABSTRACT

A kneading apparatus (21) that makes it possible to easily obtain a kneaded material having a favorable property includes: a screw (23) for extruding polyethylene which has been fed through a feed opening (27); a first heater (24) for heating the polyethylene which is extruded by the screw (23); and a second heater (25) for preheating liquid paraffin which is to be added, through a side-feed opening (28), to the polyethylene which is extruded by the screw (23).

This Nonprovisional application claims priority under 35 U.S.C. § 119 on Patent Application No. 2017-041090 filed in Japan on Mar. 3, 2017, the entire contents of which are hereby incorporated by reference.

### TECHNICAL FIELD

The present invention relates to a kneading apparatus, in which a plasticizer is side-fed and added to a material that is concurrently heated and extruded after feeding of the material through a feed opening, and a method of producing a kneaded material.

### BACKGROUND ART

As a conventional technique, a twin-screw extruder (kneading apparatus) has been known (Patent Literature 1). In this twin-screw extruder, powder polyvinyl alcohol (PVA, material) is fed to a screw through a material feed opening and then a plasticizer (additive) is side-fed through a side-feed opening and added to the polyvinyl alcohol which will be extruded by the screw.

Further, known as another conventional technique is a configuration in which liquid paraffin is side-fed and added to high-density polyethylene which has been fed to the twin-screw extruder (Patent Literature 2).

### CITATION LIST

### Patent Literature

[Patent Literature 1] Japanese Patent Application Publication, Tokukai, No. 2002-254492 (Publication Date: Sep. 11, 2002)

[Patent Literature 2]

Japanese Patent Application Publication, Tokukaihei, No. 11-60789 (Publication Date: Mar. 5, 1999)

### SUMMARY OF INVENTION

### Technical Problem

In conventional techniques as described above, there may be a case where: molecular chains of a material are loosened and intertangled with each other; and then, the material is extruded by a screw while the material is being heated. This is intended to obtain a kneaded material having a favorable property by sufficiently mixing the material.

However, in such conventional techniques, a plasticizer at room temperature is side-fed and added to the material, when the material being heated reaches the side-feed opening after the material has been fed to the screw through the material feed opening. In this case, the material heated is cooled by the plasticizer at room temperature. This results in a problem that preferred kneading of the material and the plasticizer is hindered, so that a kneaded material having a favorable property cannot be obtained.

Further, in a case where a plasticizer at room temperature is side-fed, a kneading section and the material are more rapidly cooled down in the vicinity of the side-feed opening. This leads to a problem that since a viscosity of the material locally increases in the vicinity of the side-feed opening, a discharging ability of the kneader becomes unstable. Further, in order to improve a kneaded state of the material and the plasticizer from a state in which suitable kneading of the material and the plasticizer is hindered as in the above case, it is necessary (i) to increase a length of a resin kneading section on a downstream side of the side-feed opening and/or (ii) to increase a length of a time for which the material is retained in the resin kneading section. This sometimes leads to deterioration of productivity in kneading the plasticizer into the material.

An object of an aspect of the present invention is to provide a kneading apparatus that makes it possible to easily obtain a kneaded material having a favorable property by concurrently heating and kneading a material in a preferred manner, and a method of producing the kneaded material.

### Solution to Problem

In order to solve the above problem, a kneading apparatus in accordance with an aspect of the present invention includes: a screw for extruding a material which has been fed through a feed opening; a first heater for heating the material which is extruded by the screw; and a second heater for preheating a plasticizer which is to be fed through a side-feed opening provided on a downstream side of the feed opening, the plasticizer being added to the material which is concurrently heated by the first heater and extruded by the screw.

In order to solve the above problem, a method of producing a kneaded material, in accordance with an aspect of the present invention, includes the steps of: extruding, by a screw, a material which has been fed through a feed opening; heating the material which is extruded by the screw; and adding a plasticizer, through a side-feed opening provided on a downstream side of the feed opening, to the material which is concurrently heated by the step of heating and extruded by the screw, the plasticizer having been heated prior to the step of adding the plasticizer.

### Advantageous Effects of Invention

An aspect of the present invention advantageously makes it possible to provide a kneading apparatus that makes it possible to easily obtain a kneaded material having a favorable property by concurrently heating and kneading a material in a preferred manner, and a method of producing the kneaded material.

### BRIEF DESCRIPTION OF DRAWINGS

FIG. 1 is a diagram schematically illustrating a cross-sectional configuration of a lithium-ion secondary battery in accordance with Embodiment 1.

FIG. 2 provides diagrams schematically illustrating details of the configuration of the lithium-ion secondary battery illustrated in FIG. 1.

FIG. 3 provides diagrams schematically illustrating another configuration of the lithium-ion secondary battery illustrated in FIG. 1.

FIG. 4 is a perspective view schematically illustrating a kneading apparatus for a separator original sheet of the lithium-ion secondary battery.

FIG. 5 is a diagram schematically illustrating main parts of a kneading apparatus in accordance with Embodiment 2 of the present invention.

### DESCRIPTION OF EMBODIMENTS

The following description will discuss embodiments of the present invention in detail.

### Embodiment 1

The following description will discuss, in order, a lithium-ion secondary battery, a battery separator, a heat-resistant separator, a heat-resistant separator producing method, and a kneading step in accordance with Embodiment 1.

<Lithium-Ion Secondary Battery>

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

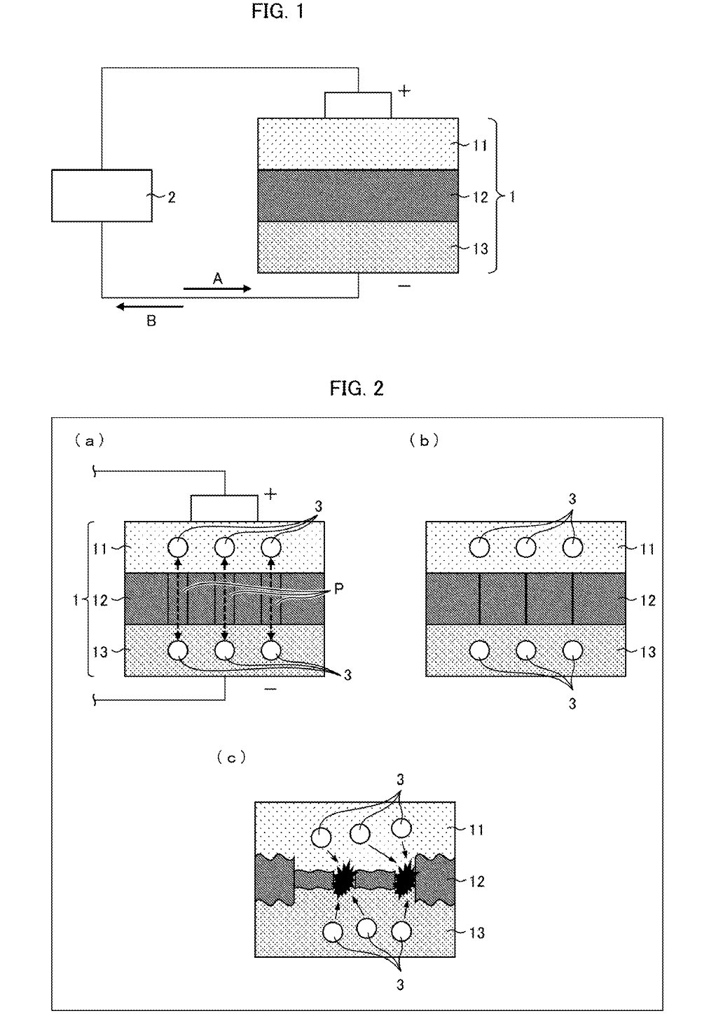

FIG. 1 is a diagram schematically illustrating a cross-sectional configuration of a lithium-ion secondary battery 1. As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

<Separator>

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

FIG. 2 provides diagrams schematically illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens, and the pores P are blocked as illustrated in (b) of FIG. 2. As a result, the separator 12 contracts. This stops the above back-and-forth movement of the lithium ions 3, and consequently stops the above temperature rise.

However, in a case where a temperature of the lithium-ion secondary battery 1 sharply rises, the separator 12 suddenly contracts. In this case, as illustrated in (c) of FIG. 2, the separator 12 may be destroyed. Then, the lithium ions 3 leak out from the separator 12 which has been destroyed. As a result, the lithium ions 3 do not stop moving back and forth. Consequently, the temperature continues rising.

<Heat-Resistant Separator>

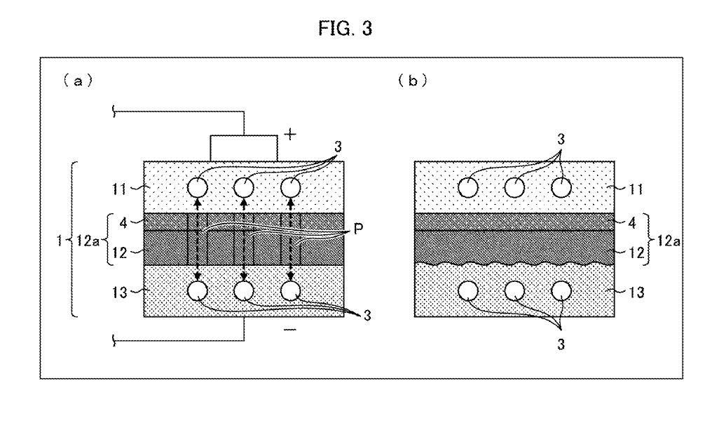

FIG. 3 provides diagrams schematically illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the lithium-ion secondary battery 1 can further include a heat-resistant layer 4. The heat-resistant layer 4 and the separator 12 form a heat-resistant separator 12a (separator). The heat-resistant layer 4 is provided on a surface of the separator 12 which surface is on a cathode 11 side. Note that the heat-resistant layer 4 can be alternatively provided on a surface of the separator 12 which surface is on an anode 13 side, or on both surfaces of the separator 12. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and accordingly the separator 12 has melted or softened, the shape of the separator 12 is maintained because the heat-resistant layer 4 supports the separator 12. Therefore, such a sharp temperature rise results in only melting or softening of the separator 12 and consequent blocking of the pores P. This stops back-and-forth movement of the lithium ions 3 and consequently stops the above-described excessive discharging or excessive charging. In this way, the separator 12 can be prevented from being destroyed.

<Steps of Producing Heat-Resistant Separator Original Sheet (Separator Original Sheet)>

How to produce the heat-resistant separator 12a of the lithium-ion secondary battery 1 is not specifically limited. The heat-resistant separator 12a can be produced by a well-known method. The following discussion assumes a case where the separator 12 contains polyethylene as a main material. However, even in a case where the separator 12 contains another material, the similar steps can still be applied to production of the heat-resistant separator 12a.

For example, it is possible to employ a method including the steps of first forming a film by adding a plasticizer to a thermoplastic resin (resin material), and then removing the plasticizer with an appropriate solvent. For example, in a case where the separator 12 is a polyolefin separator made of a polyethylene resin containing high molecular weight polyethylene, it is possible to produce the separator 12 by the following method.

This method includes (1) a kneading step of obtaining a polyethylene resin composition by kneading a high molecular weight polyethylene with a plasticizer (for example, liquid paraffin), (2) a film forming step of forming a film with the polyethylene resin composition, (3) a removal step of removing the plasticizer from the film obtained in the step (2), and (4) a stretching step of obtaining the separator 12 by stretching the film obtained in the step (3). The step (4) can alternatively be carried out between the steps (2) and (3).

In the removal step, many fine pores are provided in the film. The fine pores of the film stretched in the stretching step become the above-described pores P. The separator 12 formed as a result is a polyethylene microporous film having a prescribed thickness and a prescribed air permeability.

Note that a ratio between a polyolefin resin and the plasticizer in the kneading step is preferably a ratio which not only allows for uniform melt kneading but also is sufficient to form a microporous film precursor in a sheet form, and in addition, the ratio is preferably at a level that does not deteriorate productivity.

A weight fraction of the plasticizer in a composition made of the polyolefin resin and the plasticizer is preferably 30% by weight to 80% by weight, and further preferably 40% by weight to 70% by weight.

In a case where the weight fraction of the plasticizer is not more than 80% by weight, a melt tension is less likely to be insufficient in melt molding and moldability tends to be improved. The weight fraction of not more than 80% by weight of the plasticizer is therefore preferable.

Meanwhile, in a case where the weight fraction of the plasticizer is not less than 30% by weight, a thickness of film decreases as a stretch ratio increases. This makes it possible to obtain a thin film. The weight fraction of the plasticizer of not less than 30% by weight is therefore preferable.

Further, in a case where the weight fraction of the plasticizer is not less than 30% by weight, a sufficient plasticizing effect is obtained. Accordingly, chain-folded crystalline lamellae can be efficiently stretched. This prevents polyolefin chains from being cut due to stretching at a high stretch ratio, and allows for producing a uniformly kneaded material that has a microporous structure. This makes it easy to increase strength of the film. Further, the weight fraction of the plasticizer of not less than 30% by weight leads to reduction in extrusion load and consequent improvement in productivity.

Thereafter, in a coating step, the heat-resistant layer 4 is formed on a surface of the separator 12. For example, on the separator 12, an aramid/NMP (N-methylpyrrolidone) solution (coating solution) is applied, and thereby, the heat-resistant layer 4 that is an aramid heat-resistant layer is formed. The heat-resistant layer 4 can be provided on only one surface or both surfaces of the separator 12. Alternatively, the heat-resistant layer 4 can be formed by using, for coating, a mixed solution containing a filler such as alumina/carboxymethyl cellulose.

Further, in the coating step, a polyvinylidene fluoride/dimethylacetamide solution (coating solution) can be applied (applying step) to a surface of the separator 12 and solidified (solidifying step) so that an adhesive layer is formed on the surface of the separator 12. The adhesive layer can be provided on only one surface or both surfaces of the separator 12.

A method for coating the separator 12 with a coating solution is not specifically limited as long as uniform wet coating can be performed by the method. The method can be a conventionally well-known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film, a solid-content concentration which is the sum of concentrations of a binder and a filler in the coating solution, and a ratio of the filler to the binder.

It is possible to use a resin film, a metal belt, a drum or the like as a support with which the separator 12 is fixed or conveyed in coating.

In the above described way, the separator original sheet can be produced.

<Kneading Step>

The following description will discuss the kneading step in detail.

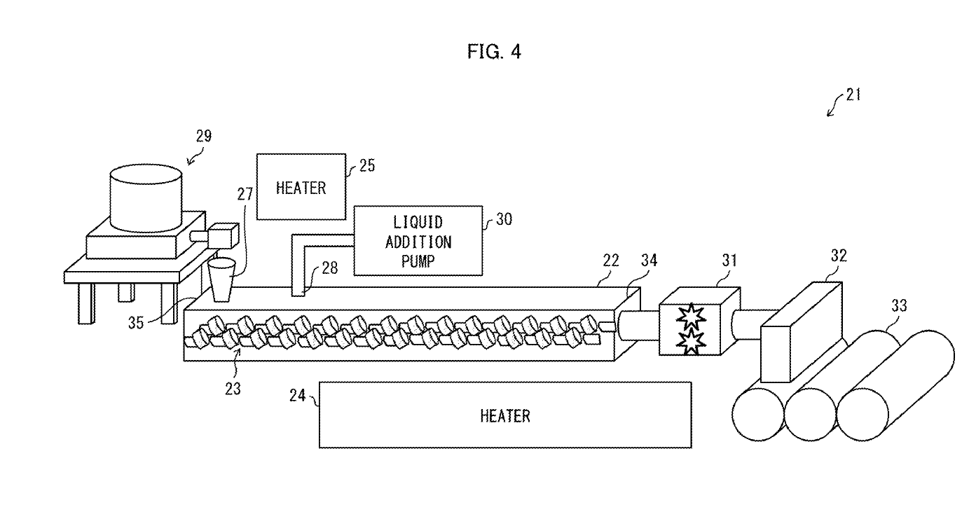

FIG. 4 is a perspective view schematically illustrating a kneading apparatus 21 for a separator original sheet of the lithium-ion secondary battery 1. The kneading apparatus 21 includes a cylinder 22 that is rectangular. The cylinder 22 includes a screw 23 that is a twin screw. The cylinder 22 is also provided with a feed opening 27 at one end of the cylinder 22 in an axis direction of the cylinder 22.

The kneading apparatus 21 is also provided with a feeder 29 at a position adjacent to the cylinder 22. The feeder 29 contains polyolefin (resin material). The feeder 29 feeds the polyolefin to the screw 23 through the feed opening 27. The kneading apparatus 21 is further provided with a gear pump 31 and a T-die 32 on a downstream side of the cylinder 22. Below the T-die 32, a cooling and polishing roller 33 is provided.

Examples of the polyolefin include high molecular weight homopolymers and copolymers produced through polymerization of ethylene, propylene, 1-butene, 4-methyl-1-pentene, and 1-hexene. A mixture of two or more of polyolefins selected from the group consisting of the above high molecular weight homopolymers and copolymers can be also used. Typical examples of the above polymers include low-density polyethylene, linear low-density polyethylene, medium-density polyethylene, high-density polyethylene, ultra-high molecular weight polyethylene, isotactic polypropylene, atactic polypropylene, polybutene, and ethylene propylene rubber. Among these examples, particularly, a high molecular weight polyethylene containing ethylene as a main component is preferable. The separator 12 may contain a component(s) other than polyolefin as long as such a component does not impair the function of the separator 12 as a polyolefin separator.

The kneading apparatus 21 further includes a heater 24 (first heater). The heater 24 heats the cylinder 22, the gear pump 31 and the T-die 32 at a preset temperature (e.g., 210° C.).

The cylinder 22 is provided with a side-feed opening 28 on a downstream side of the feed opening 27. The kneading apparatus 21 is also provided with a liquid addition pump and a heater 25 (second heater). The liquid addition pump 30 feeds liquid paraffin (plasticizer). An amount of the plasticizer fed here is 80% by weight of a total weight of the above resin material and the plasticizer. The heater 25 heats the liquid paraffin fed by the liquid addition pump 30. The liquid paraffin heated by the heater 25 is added, through the side-feed opening 28, to polyethylene that is to be extruded by the screw 23.

The polyethylene to which the liquid paraffin has been added is concurrently kneaded and extruded by the screw 23, and becomes a polyethylene resin composition. This polyethylene resin composition is fed to the cooling and polishing roller 33 via the gear pump 31 and the T-die 32. Subsequently, the polyethylene resin composition fed to the cooling and polishing roller 33 is stretched by the cooling and polishing roller 33 and, as a result, becomes a film.

The plasticizer is preferably in the form of liquid at normal temperature. Examples of the plasticizer existing in the form of liquid at normal temperature include: liquid paraffin; phthalate esters such as dibutyl phthalate, bis(2-ethylhexyl)phthalate), dioctyl phthalate, and dinonyl phthalate; and unsaturated higher alcohols such as oleyl alcohol.

All the plasticizer to be added to the resin material is fed through the side-feed opening 28.

The side-feed opening 28 is preferably provided at a position that is closer to an upstream end 35 of the cylinder 22 including the screw 23 than a downstream end 34 of the cylinder 22.

In this way, the plasticizer preheated by the heater 25 is added to the resin material which is concurrently heated by the heater 24 and extruded by the screw 23. This can prevent the plasticizer at room temperature from being side-fed and added to the resin material, when the resin material being heated reaches the side-feed opening 28 after the resin material has been fed to the screw 23 through the feed opening 27.

This consequently makes it possible to prevent a situation in which a kneading section and the resin material are rapidly cooled in the vicinity of the side-feed opening 28. This accordingly solves the problem that since a viscosity of the resin material locally increases in the vicinity of the side-feed opening 28, a discharging ability of the kneading apparatus 21 becomes unstable.

Further, the resin material is prevented from being rapidly cooled by the plasticizer at room temperature. Accordingly, it becomes unnecessary (i) to increase a length of a resin kneading section on a downstream side of the side-feed opening and/or (ii) to increase a length of a time for which the resin material is retained in the resin kneading section, so as to improve a kneaded state of the resin material and the plasticizer from a state in which suitable kneading of the material and the plasticizer is hindered. This consequently prevents deterioration in productivity in kneading of the plasticizer into the resin material.

This advantageously makes it possible to obtain a kneaded material having a favorable property while a discharging ability of the kneading apparatus 21 and productivity of the resin material are not decreased. An effect similar to this is also produced by the following Embodiments.

### Embodiment 2

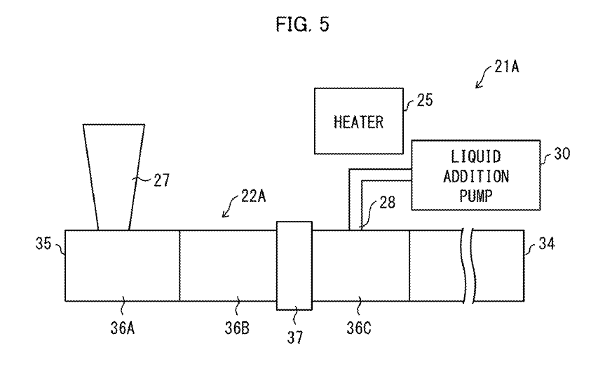

FIG. 5 is a diagram schematically illustrating main parts of a kneading apparatus 21A in accordance with Embodiment 2 of the present invention. Elements which are the same as those described above with reference to FIG. 4 are given the same reference signs and detailed explanations thereof will not be repeated.

The kneading apparatus 21A is different from the kneading apparatus 21 described above with reference to FIG. 4 in Embodiment 1, in that the kneading apparatus 21A includes a resin retaining section 37.

The kneading apparatus 21A includes a cylinder 22A. The cylinder 22A includes: a first segment 36A for transferring a resin material fed through a feed opening 27; a second segment 36B for plasticizing the resin material thus transferred; and a third segment 36C which is provided, on a downstream side of the second segment 36B, for side-feeding of liquid paraffin (plasticizer) through a side-feed opening 28. The resin retaining section 37 is provided at the boundary of the second segment 36B and the third segment 36C so as to retain the resin material in the cylinder 22A. The resin retaining section 37 may be provided at a downstream end of the second segment 36B.

The resin retaining section 37 can be configured by using a screw element which is not designed for forward transfer. Examples of the screw element include a reverse kneading disc, a reverse flight, a seal ring, and a neutral kneading disc.

In a case where the resin material fed through the feed opening 27 and insufficiently plasticized is mixed with fluid paraffin which is fed through the side-feed opening 28, the temperature of the resin material decreases more and plasticization of the resin material becomes more difficult. As a result, the resin material cannot be kneaded in a preferred manner with liquid paraffin. As a result, the resin material having not been kneaded in a preferred manner with liquid paraffin is directly extruded from the cylinder 22A. This may cause a film extruded from the T-die 32 to appear to contain resin particles (FIG. 4).

In Embodiment 2, the resin retaining section 37 is provided on an upstream side of the side-feed opening 28. In this configuration, the resin retaining section 37 pushes back the resin material and thereby a space is produced, so that liquid paraffin can be fed to the space. In this way, the side-feed opening 28 is provided at a position corresponding to the position of the resin retaining section 37.

If the resin retaining section 37 is provided directly below the side-feed opening 28, liquid paraffin fed through a pipe from a liquid addition pump 30 will be blocked by the resin material being transferred in the cylinder 22A. This results in an increased pressure inside the cylinder 22A. On this account, the liquid paraffin flows backward into the pipe and cannot be pushed into the cylinder 22A. Therefore, it is not preferable to provide the resin retaining section 37 directly below the side-feed opening 28.

The kneading apparatus 21A may be a twin-screw kneader or a single-screw kneader. The same applies to the kneading apparatus 21 illustrated in FIG. 4.

### Embodiment 3

Though the above Embodiments 1 and 2 have discussed example cases where a plasticizer exists in the form of liquid at normal temperature, the present invention is not limited to such example cases. The plasticizer may exist in the form of solid at normal temperature. Examples of the plasticizer existing in the form of solid at normal temperature include: paraffin wax, and saturated higher alcohols such as stearyl alcohol. Note that in a case where the plasticizer existing in the form of solid at normal temperature is fed through a side-feed opening 28, the plasticizer may be heated to flow by providing, on an upstream side of the heater 25, a mechanism for heating the plasticizer in the form of solid to a temperature higher than a melting point of the plasticizer. Alternatively, the plasticizer in the form of powder may be directly fed to the heater 25 without use of the liquid addition pump 30.

In a case where the plasticizer existing in the form of solid at normal temperature is used, phase separation of the plasticizer from polyolefin (resin material) is promoted when a mixture of the polyolefin and the plasticizer is extruded from a T-die 32 and cooled. In contrast, in a case where the plasticizer existing in the form of liquid at normal temperature is used, the plasticizer in the form of liquid adheres to a surface of film when the plasticizer is phase-separated. This may result in, for example, a problem that the film slips and meanders during transfer of the film on rollers, and/or a problem that the plasticizer in the form of liquid contaminates the rollers and a periphery of the rollers. Use of the plasticizer existing in the form of solid at normal temperature solves such problems. Since the plasticizer existing in the form of solid at normal temperature has a high boiling point, such a plasticizer can be more easily separated from a cleaning liquid used in a removal step as compared to the plasticizer existing in the form of liquid at normal temperature.

### Embodiment 4

Though the above Embodiments 1 to 3 have discussed example cases where all plasticizer to be added to polyolefin is fed through a side-feed opening 28, embodiments of the present invention are not limited to such example cases. Part of the plasticizer may be mixed with polyolefin in advance and a resultant mixture thus obtained may be fed through a feed opening 27.

In a case where part of the plasticizer is added to polyolefin to be fed through the feed opening 27 as described above, the polyolefin is plasticized by the plasticizer before the polyolefin reaches the side-feed opening 28. This reduces an amount of heat which is applied to the polyolefin before the polyolefin reaches the side-feed opening 28. As discussed above in Embodiment 2, in a case where the resin material fed through the feed opening 27 and insufficiently plasticized is mixed with fluid paraffin which is fed through the side-feed opening 28, the temperature of the resin material decreases more and plasticization of the resin material becomes more difficult. As a result, the resin material cannot be kneaded in a preferred manner with liquid paraffin. In contrast, in a case where part of the plasticizer is added to polyolefin to be fed through the feed opening 27 as in Embodiment 4, the polyolefin is plasticized by the plasticizer before the polyolefin reaches the side-feed opening 28. Accordingly, the polyolefin and the plasticizer (e.g., liquid paraffin) are mixed with each other in a preferred manner.

In a case where polyolefin and part of the plasticizer are mixed with each other in advance, an amount of the part of the plasticizer to be fed together with the polyolefin is preferably more than 0% by weight and not more than 50% by weight with respect to a total weight of the plasticizer to be added to the polyolefin. Note that when the amount of the part of the plasticizer, which part is to be fed through the feed opening 27 together with polyolefin, exceeds 50% by weight of the total weight of the plasticizer, particles of the polyolefin remain and float in the plasticizer. As a result, such polyolefin and the plasticizer (liquid paraffin) cannot be kneaded in a preferred manner. Therefore, the amount of the part of the plasticizer exceeding 50% by weight of the total weight of the plasticizer is not preferable.

[Recap]

As described above, according to an embodiment of the present invention, a kneading apparatus 21 includes: a screw 23 for extruding a resin material (polyethylene) which has been fed through a feed opening 27; a first heater (heater 24) for heating the resin material (polyethylene) which is extruded by the screw 23; and a second heater (heater 25) for preheating a plasticizer (liquid paraffin) which is to be fed through a side-feed opening 28 provided on a downstream side of the feed opening 27, the plasticizer being added to the resin material (polyethylene) which is concurrently heated by the first heater (heater 24) and extruded by the screw 23.

In the above configuration, the plasticizer preheated by the second heater is added to the resin material which is concurrently heated by the first heater and extruded by the screw. This prevents the plasticizer at room temperature from being side-fed and added to the resin material, when the resin material being heated reaches the side-feed opening after the resin material has been fed to the screw through the feed opening. The above configuration results in prevention of a problem that a kneaded material having a favorable property becomes difficult to obtain, because the above configuration prevents the resin material heated from being cooled by the plasticizer at room temperature, which plasticizer is side-fed, and accordingly, preferred kneading of the resin material and the plasticizer is not hindered. As a result, the above configuration allows for providing a kneading apparatus that makes it possible to easily obtain a kneaded material having a favorable property by concurrently heating and kneading the resin material in a preferred manner, and a method of producing the kneaded material.

The kneading apparatus 21 in accordance with an embodiment of the present invention is preferably configured to further include: a resin retaining section 37 for allowing the screw 23 to push back the resin material (polyethylene), the side-feed opening 28 being provided at a position corresponding to a position of the resin retaining section 37.

The above configuration allows the plasticizer to be fed to a space that is produced when the resin retaining section pushes back the resin material.

The kneading apparatus 21 in accordance with an embodiment of the present invention is preferably configured such that the side-feed opening 28 is provided at a position that is closer to an upstream end 35 of a cylinder 22 including the screw 23 than a downstream end 34 of the cylinder 22.

The above configuration makes it possible to obtain a sufficiently kneaded resin composition. This is because the above configuration provides a longer distance for softening and kneading the resin material with the plasticizer, so that resin molecules are loosened and intertangled well with each other.

The kneading apparatus 21 in accordance with an embodiment of the present invention is preferably configured such that the resin retaining section 37 is provided on an upstream side of the side-feed opening 23.

The above configuration makes it easy to feed the plasticizer to a space which is produced when the resin retaining section pushes back the resin material.

The kneading apparatus 21 in accordance with an embodiment of the present invention is preferably configured such that the plasticizer is a solid plasticizer.

In the above configuration, phase separation of the plasticizer from the resin material is promoted when a mixture of the resin material and the solid plasticizer is extruded and cooled.

The kneading apparatus 21 in accordance with an embodiment of the present invention is preferably configured such that part of the plasticizer is added to the resin material which is to be fed through the feed opening 28.

In the above configuration, the resin material is plasticized by the plasticizer before the resin material reaches the side-feed opening. This reduces an amount of heat which is applied to the resin material before the resin material reaches the side-feed opening.

A method of producing a kneaded material, in accordance with an embodiment of the present invention, includes the steps of: extruding, by a screw 23, a resin material (polyethylene) which has been fed through a feed opening 27; heating the resin material (polyethylene) which is extruded by the screw 23; and adding a plasticizer (liquid paraffin), through a side-feed opening 28 provided on a downstream side of the feed opening 27, to the resin material (polyethylene) which is concurrently heated by the step of heating and extruded by the screw 23, the plasticizer (liquid paraffin) having been heated prior to the step of adding the plasticizer.

The method in accordance with an embodiment of the present invention for producing a kneaded material is preferably configured such that when part of the plasticizer (liquid paraffin) is fed together with the resin material (polyethylene) through the feed opening 27, an amount of the part of the plasticizer fed together with the resin material (polyethylene) is more than 0% by weight and not more than 50% by weight with respect to a total weight of the plasticizer (liquid paraffin).

In the above configuration, the resin material is plasticized by the plasticizer before the resin material reaches the side-feed opening. This reduces an amount of heat which is applied to the resin material before the polyolefin reaches the side-feed opening.

The method in accordance with an embodiment of the present invention is preferably configured such that the resin material is pushed back on an upstream side of the side-feed opening 28.

This configuration makes it possible to feed the plasticizer to a space which is produced when the resin material is pushed back.

The method in accordance with an embodiment of the present invention is preferably configured such that the plasticizer is a solid plasticizer.

In the above configuration, phase separation of the plasticizer from the resin material is promoted when a mixture of the resin material and the solid plasticizer is extruded and cooled.

The method in accordance with an embodiment of the present invention is preferably configured such that part of the plasticizer is added to the resin material which is to be fed through the feed opening.

In the above configuration, the resin material is plasticized by the plasticizer before the resin material reaches the side-feed opening. This reduces an amount of heat which is applied to the resin material before the resin material reaches the side-feed opening.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

21 kneading apparatus
22 cylinder
23 screw
24 heater (first heater)
25 heater (second heater)
27 feed opening
28 side-feed opening
37 resin retaining section

1. A kneading apparatus comprising:
a screw for extruding a resin material which has been fed through a feed opening;
a first heater for heating the resin material which is extruded by the screw; and
a second heater for preheating a plasticizer which is to be fed through a side-feed opening provided on a downstream side of the feed opening, the plasticizer being added to the resin material which is concurrently heated by the first heater and extruded by the screw.

2. The kneading apparatus according to claim 1, further comprising:
a resin retaining section for allowing the screw to push back the resin material,
the side-feed opening being provided at a position corresponding to a position of the resin retaining section.

3. The kneading apparatus according to claim 2, wherein the side-feed opening is provided at a position that is closer to an upstream end of a cylinder including the screw than a downstream end of the cylinder.

4. The kneading apparatus according to claim 2, wherein the resin retaining section is provided on an upstream side of the side-feed opening.

5. The kneading apparatus according to claim 1, wherein the plasticizer is a solid plasticizer.

6. The kneading apparatus according to claim 1, wherein part of the plasticizer is added to the resin material which is to be fed through the feed opening.

7. A method of producing a kneaded material, comprising the steps of:
extruding, by a screw, a resin material which has been fed through a feed opening;
heating the resin material which is extruded by the screw; and
adding a plasticizer, through a side-feed opening provided on a downstream side of the feed opening, to the resin material which is concurrently heated by the step of heating and extruded by the screw, the plasticizer having been heated prior to the step of adding the plasticizer.

8. The method according to claim 7, wherein when part of the plasticizer is fed together with the resin material through the feed opening, an amount of the part of the plasticizer fed together with the resin material is more than 0% by weight and not more than 50% by weight with respect to a total weight of the plasticizer.

9. The method according to claim 7, wherein the resin material is pushed back on an upstream side of the side-feed opening.

10. The method according to claim 7, wherein the plasticizer is a solid plasticizer.

11. The method according to claim 7, wherein part of the plasticizer is added to the resin material which is to be fed through the feed opening.
